(19) United States
(12) Patent Application Publication
(10) Pub. No.: US 2010/0201952 A1
(43) Pub. Date: Aug. 12, 2010

(54) PROJECTOR

(75) Inventor: Toshihiko SAKAI, Minamiminowa-mura (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/700,057

(22) Filed: Feb. 4, 2010

(30) Foreign Application Priority Data
Feb. 6, 2009 (JP) 2009-025656
Feb. 23, 2009 (JP) 2009-038945

(51) Int. Cl. G03B 21/14

(52) U.S. Cl. 353/20; 353/34

(57) ABSTRACT

A projector includes first and second optical systems each having a light modulation device that modulates light emitted from a light source device, in accordance with image information input, and forms an optical image. A combining optical system combines the optical images respectively formed by the first and second optical systems. A projection optical system projects the combined optical image. The first or the second optical system includes a transparent parallel plate between the light modulation device and the combining optical system in a rotatable manner, and a tilt angle adjustment mechanism that rotates the transparent parallel plate with respect to a first axis perpendicular to a normal line of an entrance surface of the light modulation device and a second axis perpendicular to the normal line and the first axis to adjust a tilt angle of the transparent parallel plate with respect to the normal line.

### BACKGROUND

1. Technical Field

The present invention relates to a projector adapted to modulate the light ejected from a light source in accordance with image information to form an optical image, and then project the optical image.

2. Related Art

In recent years, due to the increase in the resolution of digital images, there has been proposed in projectors adapted to project a projection image on a screen a technology of providing a plurality of optical devices each for modulating the light emitted from a light source device with a light modulation element such as a light valve to thereby form an optical image, and overlapping the optical images formed by the respective optical devices in a condition in which the optical images are slid a half pixel pitch from each other in both of the vertical and horizontal directions, thereby realizing the increase in the resolution and the definition of the projection images (see, e.g., JP-A-6-123868 (Document 1)).

In the technology described in the Document 1 mentioned above, the optical images respectively formed in the two optical images (projection display modules) are enlargedly projected via the projection lenses provided to the respective optical devices, the projection images are overlapped in a condition of being slid a half pixel pitch from each other, thereby realizing the increase in the resolution and the definition of the projection images.

Here, in the technology described in the Document 1, since it is required to adjust the positions of the projection images emitted from the respective optical devices with such a high accuracy as a half pixel pitch, a light shifting element is provided on either the entrance side or the reflection side of each of the projection lenses, and the amount of the light shift of each of the light shifting elements is adjusted, thereby overlapping the projection images slid a half pixel pitch from each other.

In the technology described in JP-A-2005-128506 (Document 2), an image light transmitted through the liquid crystal display panel is enlargedly projected by the projection lens via a variable apex angle prism. The variable apex angle prism is configured so that the apex angle of the prism is varied by an actuator, and is adopted as an optical hand tremor correcting device.

However, in the technology described in the Document 1 mentioned above, since each of the optical devices has the projection lens, and the projection images emitted from the respective projection lenses are overlapped with each other, there arises a problem that it is difficult to overlap the projection images in the state of being slid a half pixel pitch from each other with high accuracy throughout the entire projection images due to the influence of the aberration and the distortion inherent to each of the projection lenses.

Further, in the technology described in the Document 1 mentioned above, since the projection lens is provided to each of the optical devices, there also arises a problem that downsizing and weight saving thereof are difficult.

Still further, it is also possible to adopt a method of combining the optical images respectively formed by a plurality of optical devices with a combining optical device, and then emitting the optical images thus combined from a single projection lens, and to adopt a configuration of making the position of either one of the entire optical devices adjustable.

However, in the case of adopting such a structure, although it is possible to perform the overlapping in the entire projection images with high accuracy without coming under the influence of the aberration and the distortion inherent to the projection lens, since it is required to provide a position adjustment device of the optical device, there arises a problem that it is difficult to achieve the downsizing and the weight saving similarly to the case described above.

Further, in the technology described in the Document 2 mentioned above, the apex angle prism is used as nothing more than a device for optical hand tremor correction, and therefore, increase in the resolution of the projection image is not achievable.

### SUMMARY

An advantage of the invention is to provide a projector capable of adjusting the pixel positions with high accuracy when overlapping a plurality of projection images in the state of being slid a half pixel pitch from each other, and at the same time, achieving the downsizing and the weight saving of the projector.

According to an aspect of the invention, there is provided a projector including a first optical system and a second optical system each having a light modulation device adapted to modulate light, which is emitted from a light source device, in accordance with image information input, and to form an optical image, a combining optical system adapted to combine the optical images respectively formed by the first optical system and the second optical system, and a projection optical system adapted to project the combined optical image combined into by the combining optical system, wherein either one of the first optical system and the second optical system includes a transparent parallel plate disposed between the light modulation device and the combining optical system in a rotatable manner, and a tilt angle adjustment mechanism adapted to rotate the transparent parallel plate with respect to a first axis perpendicular to a normal line of an entrance surface of the light modulation device and a second axis perpendicular to the normal line and the first axis to adjust a tilt angle of the transparent parallel plate with respect to the normal line.

According to this aspect of the invention, it is possible to slide the optical image a half pixel pitch from each other by a simple configuration of providing the transparent parallel plate at a specific position, and rotating the transparent parallel plate in a specific direction using the tilt angle adjustment mechanism. Further, since the optical image slid a half pixel pitch therefrom and the optical image emitted from the optical system without the transparent parallel plate are combined in the combining optical system, and the optical image thus obtained by the combining operation is projected by the projection optical system, higher precision in the projection image can be realized.

Further, since the transparent parallel plate is disposed between the combining optical system and the projection optical system, the amount of sliding of the optical image can be reduced to be relatively small compared to the case of disposing the transparent parallel plate on the exit side of the projection optical system, the position adjustment of the optical image can be performed with good accuracy.

Further, since the optical image is slid by rotating the transparent parallel plate, the configuration in which the position adjustment of the entire optical device is possible can be eliminated, and the downsizing, the weight saving, and the reduction in the cost, of the projector can be achieved.

According to another aspect of the invention, in the projector according to the above aspect of the invention, it is preferable that the light source device includes a light source, and a polarization splitting device adapted to split the light emitted from the light source into P-polarized light parallel to an entrance surface and S-polarized light perpendicular to the entrance surface, the first optical system forms the optical image based on the P-polarized light split into by the polarization splitting device, and the second optical system forms the optical image based on the S-polarized light split into by the polarization splitting device.

According to this aspect of the invention, since the light is composed mainly of the P-polarized light and the S-polarized light, the optical image can be formed respectively based on the P-polarized light and the S-polarized light split into by the polarization splitting device. Therefore, the light efficiency can be improved. Further, since it is possible to form a light source image of the two optical systems by one light source device, the downsizing and the weight saving can be achieved.

According to still another aspect of the invention, in the projector according to the above aspect of the invention, it is preferable that each of the first optical system and the second optical system includes a color separation device adapted to separate incident light sequentially one of from longer wavelength band to shorter wavelength band and from shorter wavelength band to longer wavelength band into a red light beam, a green light beam, and a blue light beam, three light modulation sections corresponding to the light modulation device, and adapted to modulate the respective colored light beams, which are separated into by the color separation device, in accordance with the input image information to thereby form the optical images, a color combining optical device adapted to combine the optical images of the respective colored light beams formed by the respective light modulation sections, and a color polarizer disposed between the color combining optical device and the combining optical system, and adapted to change a polarization direction of the green light beam, and the transparent parallel plate is provided to the color polarizer.

Here, in the case in which the light is separated sequentially from longer wavelength band to shorter wavelength band or from shorter wavelength band to longer wavelength band into a red light beam, a green light beam, and a blue light beam, and optical images of the respective colored light beams are combined, it is possible to align the polarization directions of the red light beam and the blue light beam to be that of the S-polarized light perpendicular to the entrance surface and having high reflectance, and to set the polarization direction of the green light beam to be that of the P-polarized light having high transmission.

According to such an aspect of the invention, the polarization direction of the green light beam can be aligned by the color polarizer with the polarization directions of the red light beam and the blue light beam. Therefore, since all of the polarization directions of the green light beam, red light beam, and blue light beam constituting the color image are aligned with each other, the operability of the color optical image in the combining optical system disposed posterior to the transparent parallel plate is improved.

According to yet another aspect of the invention, in the projector according to the above aspect of the invention, it is preferable that the transparent parallel plate has a thickness equal to or larger than 0.5 mm and equal to or smaller than 30 mm.

According to this aspect of the invention, since the thickness of the transparent parallel plate is specified, the strength thereof can be ensured, and the fine adjustment of the tilt angle can easily be performed. Here, if the thickness is reduced to be smaller than 0.5 mm, the strength becomes insufficient, which might cause it to be prone to be damaged. On the other hand, in the case in which the thickness thereof exceeds 30 mm, since the amount of sliding of the optical image corresponding to only a slight variation in the tilt angle of the transparent parallel plate becomes large, it might become difficult to perform a fine adjustment by a tilt angle adjustment mechanism.

According to still yet another aspect of the invention, in the projector according to the above aspect of the invention, it is preferable that the tilt angle adjustment mechanism sets the tilt angle of the transparent parallel plate with respect to the normal line within a range larger than 0 and equal to or smaller than 5 degrees.

According to this aspect of the invention, since the tilt angle is set within a specific range, it is possible to slide the optical image a half pixel pitch with high accuracy. On the other hand, if the tilt angle exceeds 5 degrees, the optical image might be slid more than a half pixel pitch.

According to further another aspect of the invention, in the projector according to the above aspect of the invention, it is preferable that the transparent parallel plate is made of a glass material.

According to this aspect of the invention, the cost of the transparent parallel plate can be reduced. The glass material is, for example, quartz glass or crystallized glass.

According to still further another aspect of the invention, there is provided a projector including a first optical system and a second optical system each having a light modulation device adapted to modulate light, which is emitted from a light source device, in accordance with image information input, and to form an optical image, a combining optical system adapted to combine the optical images respectively formed by the first optical system and the second optical system, a projection optical system adapted to project the combined optical image combined into by the combining optical system, a variable angle prism having a pair of transparent substrates disposed between the light modulation device and the combining optical system so as to face each other with a gap, and adapted to control a distance between the pair of transparent substrates to thereby tilt at least either of the pair of transparent substrate with respect to a normal line of an image forming area of the light modulation device, and a variable angle prism adjustment mechanism adapted to adjust the tilt angle of at least either one of the pair of transparent substrates in the variable angle prism with respect to the normal line.

According to this aspect of the invention, the optical images can be slid a half pixel pitch from each other with such a simple configuration as tilting the transparent substrate of the variable angle prism by the variable angle prism adjustment mechanism. Further, since the optical image slid a half pixel pitch therefrom and the optical image emitted from the optical system without the variable angle prism are combined in the combining optical system, and the optical image thus obtained by the combining operation is projected by the projection optical system, higher precision in the projection image can be realized.

Further, since the optical image is slid by tilting the transparent substrate of the variable angle prism, the configuration in which the position adjustment of the entire optical device is possible can be eliminated, and the downsizing, the weight saving, and the reduction in the cost, of the projector can be achieved.

According to yet further another aspect of the invention, in the projector according to the above aspect of the invention, it is preferable that the light source device includes a light source, and a polarization splitting device adapted to split the light emitted from the light source into P-polarized light parallel to an entrance surface and S-polarized light perpendicular to the entrance surface, the first optical system forms the optical image based on the P-polarized light split into by the polarization splitting device, and the second optical system forms the optical image based on the S-polarized light split into by the polarization splitting device.

According to this aspect of the invention, since the light is composed mainly of the P-polarized light and the S-polarized light, the optical image can be formed respectively based on the P-polarized light and the S-polarized light split into by the polarization splitting device. Therefore, the light efficiency can be improved. Further, since it is possible to form a light source image of the two optical systems by one light source device, the downsizing and the weight saving can be achieved.

According to still yet further another aspect of the invention, in the projector according to the above aspect of the invention, it is preferable that each of the first optical system and the second optical system includes a color separation device adapted to separate incident light sequentially one of from longer wavelength band to shorter wavelength band and from shorter wavelength band to longer wavelength band into a red light beam, a green light beam, and a blue light beam, three light modulation sections corresponding to the light modulation device, and adapted to modulate the respective colored light beams, which are separated into by the color separation device, in accordance with the input image information to thereby form the optical images, a color combining optical device adapted to combine the optical images of the respective colored light beams formed by the respective light modulation sections, and a color polarizer disposed between the color combining optical device and the combining optical system, and adapted to change a polarization direction of the green light beam, and the variable angle prism is provided to the color polarizer.

Here, in the case in which the light is separated sequentially from longer wavelength band to shorter wavelength band or from shorter wavelength band to longer wavelength band into a red light beam, a green light beam, and a blue light beam, and optical images of the respective colored light beams are combined, it is possible to align the polarization directions of the red light beam and the blue light beam to be that of the S-polarized light perpendicular to the entrance surface and having high reflectance, and to set the polarization direction of the green light beam to be that of the P-polarized light having high transmission.

According to such an aspect of the invention, the polarization direction of the green light beam can be aligned by the color polarizer with the polarization directions of the red light beam and the blue light beam. Therefore, since all of the polarization directions of the green light beam, red light beam, and blue light beam constituting the color image are aligned with each other, the operability of the color optical image in the combining optical system disposed posterior to the variable angle prism is improved.

According to a further aspect of the invention, in the projector according to the above aspect of the invention, it is preferable that the variable angle prism is disposed so as to be able to transmit the optical image of the S-polarized light emitted from one of the first optical system and the second optical system, and the combining optical system includes a reflective polarizer disposed between the variable angle prism and the projection optical system, and adapted to reflect the optical image of the S-polarized light emitted from the variable angle prism and then supply the projection optical system with the optical image.

According to this aspect of the invention, since the S-polarized light has low incident angle dependency, even if the tilt angle of the end surface of the variable angle prism varies, the reflective polarizer reflects the S-polarized light in accordance with the variation. Therefore, the light can be used efficiently.

### BRIEF DESCRIPTION OF THE DRAWINGS

The invention will be described with reference to the accompanying drawings, wherein like numbers reference like elements.

FIG. 1 is a schematic diagram showing a structure of a projector according to a first embodiment of the invention.

FIGS. 2A and 2B are schematic diagrams illustrating the states A, B in which a transparent parallel plate is disposed in the embodiment described above.

FIG. 3 is a front view showing a tilt angle adjustment mechanism in the embodiment described above.

FIG. 4 is a side view showing the tilt angle adjustment mechanism in the embodiment described above.

FIG. 5 is a schematic diagram showing the state of projection images of first and second optical systems, combined by a combining optical system in the embodiment described above.

FIG. 6 is a schematic diagram showing a structure of a projector according to a second embodiment of the invention.

FIG. 7 is a front view showing a tilt angle adjustment mechanism in the embodiment described above.

FIG. 8 is a schematic diagram showing a structure of a projector according to a third embodiment of the invention.

FIGS. 9A and 9B are schematic diagrams illustrating the states A, B in which a variable angle prism is disposed in the embodiment described above.

FIG. 10 is a schematic diagram showing a structure of a projector according to a fourth embodiment of the invention.

FIG. 11 is a schematic diagram illustrating the states in which a variable angle prism is disposed in the embodiment described above.

FIG. 12 is a schematic diagram showing a structure of a projector according to a fifth embodiment of the invention.

### DESCRIPTION OF EXEMPLARY EMBODIMENTS

Some embodiments of the invention will hereinafter be explained with reference to the accompanying drawings.

### First Embodiment

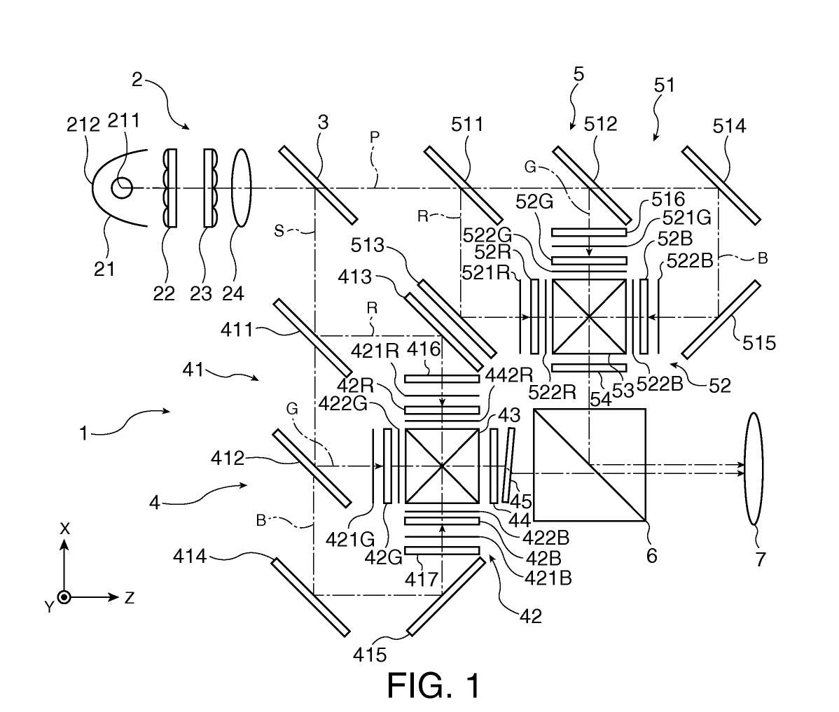

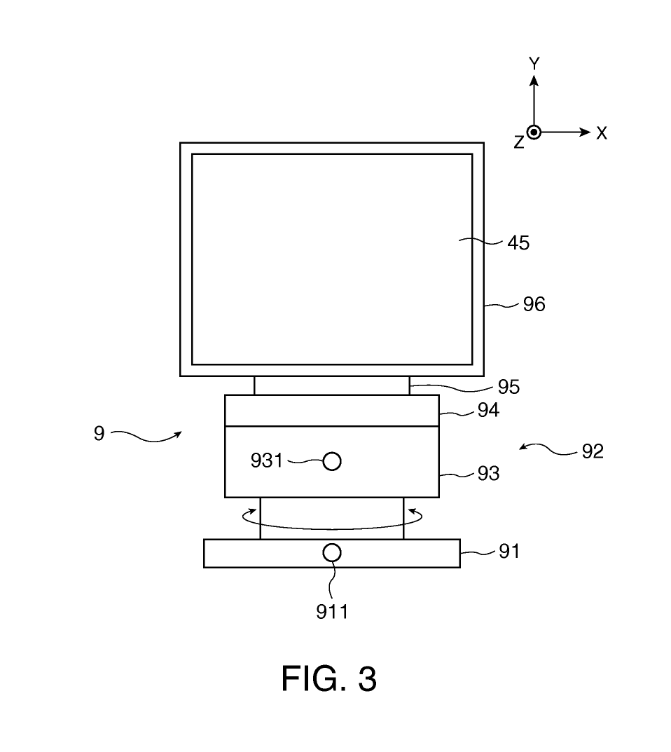

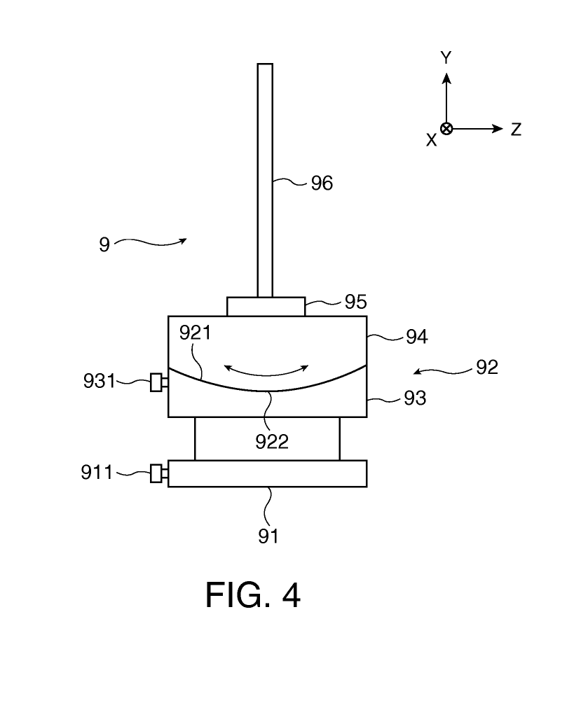

FIG. 1 shows a projector 1 according to an embodiment of the invention, and the projector 1 is provided with an illumination optical device 2, a polarization splitting device 3, a first optical system 4, a second optical system 5, a combining optical system 6, and a projection optical system 7. Further, as shown in FIGS. 3 and 4, the projector 1 is provided with a tilt angle adjustment mechanism 9 for rotating a transparent parallel plate 45 described later. Although not shown in the drawings, these optical elements are housed in the same housing. The projector 1 is for modulating the light emitted from the illumination optical device 2 in each of the first optical system 4 and the second optical system 5 in accordance with image information input thereto to thereby form optical images, combining the optical images, which are formed respectively in the optical system 4, 5, in the combining optical system 6, and projecting the optical image, which is obtained by the combining process, using the projection optical system 7. It should be noted that it is assumed that the proceeding direction of the principal ray is a Z-axis direction, and directions of the two axes along the directions perpendicular to the proceeding direction of the principal ray are an X-axis direction (a direction parallel to the sheet) and a Y-axis direction (a direction perpendicular to the sheet), respectively.

As shown in FIG. 1, the illumination optical device 2 is provided with a light source device 21, a first lens array 22, a second lens array 23, and an overlapping lens 24.

The light source device 21 is provided with a light source lamp 211 as a light source for emitting a radiated light beam, and a reflector 212 for reflecting the radiated light beam emitted from the light source lamp 211 to converge it at a predetermined position. As such a light source lamp 211, a halogen lamp, a metal halide lamp, a high-pressure mercury lamp, or the like can be used. Further, as a reflector 212, a paraboloidal reflector having a paraboloid of revolution as the reflection surface, or an ellipsoidal reflector having an ellipsoid of revolution as the reflection surface can be adopted. The light reflected by the reflector 212 is supplied to the first lens array 22.

The first lens array 22 and the second lens array 23 have a configuration in which the respective small lenses corresponding to each other are arranged in a matrix, and the first lens array 22 divides the light input from the light source device 21 into a plurality of partial light beams, and focuses the partial light beams in the vicinity of the second lens array 23.

The second lens array 23, in cooperation with the overlapping lens 24 disposed on the light path in the posterior stage of the second lens array 23, overlaps the plurality of partial light beams, which is obtained by the dividing operation of the first lens array 22, on image forming areas of liquid crystal panels 42R, 42G, 42B constituting the first optical system 4, and image forming areas of liquid crystal panels 52R, 52G, 52B constituting the second optical system 5. In the posterior stage of the overlapping lens 24, there is disposed a polarization splitting device 3.

The polarization splitting device 3 is a plate-like member disposed so as to be tilted roughly 45 degrees with respect to the center axis of the light path of the light emitted from the illumination optical device 2, and is an optical element obtained by forming a dielectric multilayer film on a transparent substrate made of, for example, BK7 or quartz glass. The dielectric multilayer film of the polarization splitting device 3 has a function of splitting the light with random polarization emitted from the illumination optical device 2 into two types of linearly polarized light, and transmits the linearly polarized light (P-polarized light) with a polarization direction parallel to the incident surface of the light, and reflects the linearly polarized light (S-polarized light) with a polarization direction perpendicular to the incident surface thereof. The S-polarized light obtained by the splitting operation of the polarization splitting device 3 is supplied to the first optical system 4 disposed so as to face straight to the projection optical system 7, while the P-polarized light is supplied to the second optical system 5 disposed in a direction perpendicular to the optical axis of the projection optical system 7.

The first optical system 4 is a section for modulating the S-polarized light obtained by the splitting operation of the polarization splitting device 3 in accordance with the image information to form an optical image, and is provided with a color separation optical device 41, a light modulation device 42, a color combining optical device 43, a color polarizer 44, and a transparent parallel plate 45.

The color separation optical device 41 has a function of separating the S-polarized light input therein into three colored light beams of a red light beam (R), a green light beam (G), and a blue light beam (B), and is provided with dichroic mirrors 411, 412, reflecting mirrors 413, 414, 415, and retardation plates 416, 417.

The dichroic mirrors 411, 412 are each an optical element disposed so as to be tilted roughly 45 degrees with respect to the center axis of the light path of the S-polarized light, and obtained by forming a dielectric multilayer film on a transparent substrate made of, for example, BK7 or quartz glass. The dielectric multilayer film of each of the dichroic mirrors 411, 412 has a function of reflecting the light in a specific wavelength band and transmitting the other light, thereby separating the S-polarized light into a plurality of colored light beams. The dichroic mirror 411 disposed on the light path in the anterior stage reflects the blue light beam (B) and transmits the other colored light beams, namely the red light beam (R) and the green light beam (G), while the dichroic mirror 412 disposed on the light path in the posterior stage reflects the green light beam (G) and transmits the red light beam (R). In the posterior stage of the dichroic mirror 411, there is disposed the reflecting mirror 413, and in the posterior stage of the dichroic mirror 412, there are disposed the reflecting mirrors 414, 415.

The reflecting mirrors 413, 414, 415 are optical elements for guiding the respective colored light beams R, G, B, which are separated into by the dichroic mirrors 411, 412, to the light modulation device 42, and are each formed of a total reflection mirror. In the posterior stage of the reflecting mirror 413, there is disposed the retardation plate 416, and in the posterior stage of the reflecting mirror 415, there is disposed the wave retardation plate 417.

The retardation plates 416, 417 are optical elements for changing the colored light beams R, B of the S-polarized light reflected by the reflecting mirrors 413, 415 into the colored light beams R, B of the P-polarized light, respectively, and are each formed of a half wave retardation plate. The retardation plates 416, 417 supply the liquid crystal panels 42R, 42B constituting the light modulation device 42 with the colored light beams R, B of the P-polarized light, respectively.

The light modulation device 42 is provided with the three liquid crystal panels 42R, 42G, 42B, three entrance side polarization plates 421R, 421G, 421B disposed on the light path in the anterior stages of the respective liquid crystal panels 42R, 42G, 42B, and three exit side polarization plates 422R, 422G, 422B disposed on the light path in the posterior stages of the respective liquid crystal panels 42R, 42G, 42B.

The three entrance side polarization plates 421R, 421G, 421B are each obtained by forming a polarization film on a transparent substrate made of, for example, BK7 or quartz glass, and the two entrance side polarization plates 421R, 421B thereof have a characteristic of transmitting the P-polarized light emitted from the retardation plates 416, 417.

The liquid crystal panels 42R, 42B each have a configuration of airtightly encapsulating liquid crystal as an electro-optic material between a pair of transparent glass substrates, and the orientation condition of the liquid crystal is controlled in accordance with the image information input thereto, thereby modulating the polarization directions of the P-polarized light beams emitted from the respective entrance side polarization plates 421R, 421B into that of the S-polarized light.

The exit side polarization plates 422R, 422B transmit only the S-polarized light out of the light emitted via the liquid crystal panels 42R, 42B, and absorb the other light. The S-polarized light thus transmitted therethrough is supplied to the color combining optical device 43.

Meanwhile, the entrance side polarization plate 421G has a characteristic of transmitting the S-polarized light obtained by the splitting operation of the polarization splitting device 3, and absorbs the light with a phase varied by, for example, the dichroic mirror 412 disposed on the light path.

The liquid crystal panel 42G has a configuration of airtightly encapsulating liquid crystal as an electro-optic material between a pair of transparent glass substrates, and the orientation condition of the liquid crystal is controlled in accordance with the image information input thereto, thereby modulating the polarization direction of the S-polarized light beam emitted from the entrance side polarization plate 421G into that of the P-polarized light.

The exit side polarization plate 422G transmits only the P-polarized light out of the light emitted via the liquid crystal panel 42G, and absorbs the other light. The P-polarized light thus transmitted therethrough is supplied to the color combining optical device 43.

The color combining optical device 43 has a function of combining the modulated light beams emitted from the respective exit side polarization plates 422R, 422G, 422B to thereby form a color image, and has a roughly square planar shape formed by bonding four rectangular prisms with each other, and is configured as a cross dichroic prism with the interfacial surfaces, on which the rectangular prisms are bonded with each other, provided with two dielectric multilayer films. One of the two dielectric multilayer films has the characteristic of reflecting the red light beam (R) and transmitting the green light beam (G), and the other thereof has the characteristic of reflecting the blue light beam (B) and transmitting the green light beam (G), and these dielectric multilayer films combine the red light beam (R), the green light beam (G), and the blue light beam (B) to thereby form the color image. The color image thus formed is supplied to the color polarizer 44 disposed posterior to the color combining optical device 43.

The color polarizer 44 is an optical element for changing the respective polarization directions of the blue light beam of the S-polarized light and the red light beam of the S-polarized light formed in the first optical system 4, and is composed of a blue color change layer for changing the S-polarized light in the blue wavelength band into the P-polarized light, and a red color change layer for changing the S-polarized light in the red wavelength band into the P-polarized light. As materials for the blue color change layer and the red color change layer, a polymer material or an inorganic material is used. As such a polymer material, there can be cited polyvinyl alcohol, polycarbonate, Mylar™, polypropylene, polystyrene, triacetate (tributyl acetate), polymethylmethacrylate, and so on. As an inorganic material, quartz crystal, mica, calcite, and so on can be cited.

The green light beam of the P-polarized light, the red light beam of the P-polarized light, and the blue light beam of the P-polarized light are supplied to the transparent parallel plate 45 disposed posterior to the color polarizer 44.

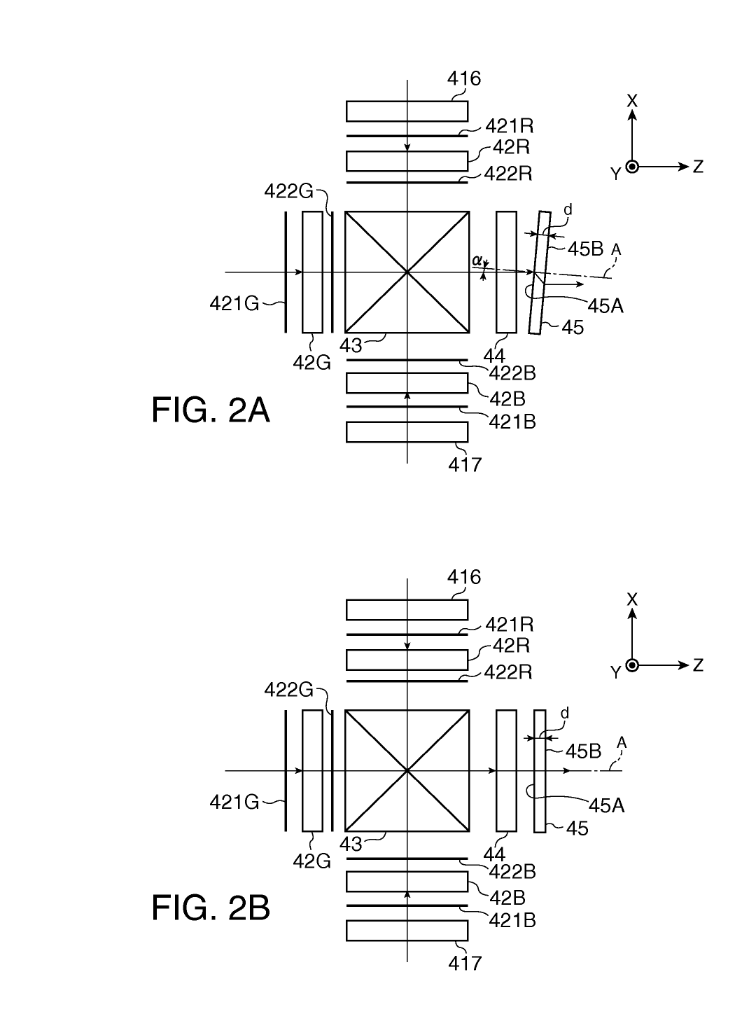

As shown in FIGS. 2A and 2B, the transparent parallel plate 45 has an entrance side plane 45A and an exit side plane 45B. Here, although the case in which the optical image is slid around the Y-axis is explained with reference to FIGS. 2A and 2B, the same applies to the case in which the optical image is slid around the X-axis. It should be noted that the first axis described above corresponds to the Y-axis perpendicular to the normal line A of the entrance surface, and the second axis corresponds to the X-axis perpendicular to both of the normal line A and the Y-axis.

As shown in FIG. 2A, the entrance side plane 45A is tilted so that the principal ray of the P-polarized light emitted from the color polarizer 44 is at a tilt angle (α) with the normal line A. The tilt angle (α degree) preferably satisfies 0<α≦10, and further preferably satisfies 0≦α≦5. If the tilt angle (α degree) exceeds 10 degrees, the astigmatism might increase to make the imaging performance unworkable. In contrast, in the case in which the entrance side plane 45A is perpendicular (α=0) to the normal line A, as shown in FIG. 2B, the optical image is transmitted without sliding.

Further, the thickness (d) of the transparent parallel plate 45 is preferably no smaller than 0.5 mm and no larger than 30 mm. In the case in which the thickness is smaller than 0.5 mm, the strength of the transparent parallel plate 45 becomes insufficient, which might cause it to be prone to be damaged. On the other hand, in the case in which the thickness thereof exceeds 30 mm, since the amount of sliding of the optical image corresponding to only a slight variation in the tilt angle of the transparent parallel plate 45 becomes large, it might become difficult to perform a fine adjustment by a tilt angle adjustment mechanism 9 described later.

The transparent parallel plate 45 is preferably made of a glass material. As the glass material, BK7, quartz glass, crystallized glass, and so on can be cited as examples. Further, the glass material preferably has characteristics of nd=1.51680, and rd=64.2.

The tilt angle adjustment mechanism 9 is a mechanism for rotating the transparent parallel plate 45 with respect to the Y-axis and the X-axis, and has a configuration of rotatably supporting a one-axis gonio-stage 92 on a support stage 91.

The gonio-stage 92 rotates on the support stage 91 to thereby rotate the transparent parallel plate 45 around the Y-axis. It should be noted that the gonio-stage 92 is rotated on the support stage 91 by operating a Y-axis rotating knob 911 provided to the support stage 91.

The gonio-stage 92 is provided with a lower receiving section 93 and an upper sliding section 94.

On the upper end surface of the lower receiving section 93 is provided with a concave surface 921 formed as an inside surface of a cylinder having a circular cross-section along the direction of the Z-axis forming the axis of the principal ray of the projector 1.

The upper part of the upper sliding section 94 is provided with a holding frame 96 via a coupling section 95, and the transparent parallel plate 45 is held by the holding frame 96.

Further, the lower end surface of the upper sliding section 94 is formed to have a convex surface 922 shaped along the concave surface 921, and by the convex surface 922 sliding on the concave surface 921, the transparent parallel plate 45 is rotated around the X-axis. It should be noted that regarding the rotation around the X-axis, it becomes possible to rotate the upper sliding section 94 around the X-axis by operating an X-axis rotating knob 931 provided to the lower receiving section 93.

As shown in FIG. 1, the second optical system 5 is a part for modulating the P-polarized light obtained by the splitting operation of the polarization splitting device 3 in accordance with the image information to thereby form the optical image, and is provided with a color separation optical device 51, a light modulation device 52, a color combining optical device 53, and a color polarizer 54 in basically the same manner as in the first optical system 4, and functions and operations thereof are basically the same as those of the first optical system 4.

Although the color separation optical device 51 is provided with the dichroic mirrors 511, 512 and the reflecting mirrors 513, 514, 515, the dichroic mirror 511 disposed on the light path of the P-polarized light in the anterior stage is provided with a dielectric multilayer film, which reflects the red light beam (R) and transmits the green light beam (G) and the blue light beam (B), formed on a transparent substrate, and the dichroic mirror 512 disposed in the posterior stage is provided with a dielectric multilayer film, which reflects the green light beam (G) and transmits the blue light beam (B), formed on a transparent substrate.

Similarly to the case of the first optical system 4, the light modulation device 52 is provided with the three liquid crystal panels 52R, 52G, 52B, entrance side polarization plates 521R, 521G, 521B disposed on the light path in the anterior stages of the respective liquid crystal panels 52R, 52G, 52B, and exit side polarization plates 522R, 522G, 522B disposed on the light path in the posterior stages of the respective liquid crystal panels 52R, 52G, 52B. However, unlike the first optical system 4, the second optical system 5 is not provided with the retardation plates 416, 417, and the transparent parallel plate 45, and is different therefrom in that a retardation plate 516 and a color polarizer 54 are provided.

The retardation plate 516 is disposed between the dichroic mirror 512 and the entrance side polarization plate 521G, and changes the green light beam of the P-polarized light emitted from the dichroic mirror 512 into the S-polarized light, and then emit it to the entrance side polarization plate 521G.

The color polarizer 54 is an optical element for changing the green light beam of the P-polarized light formed by the second optical system 5 into the green light beam of the S-polarized light, and is configured including a green color change layer for changing the polarized light in the green wavelength band. Further, the color polarizer 54 supplies the combining optical system 6 with the green light beam of the S-polarized light, the red light beam of the S-polarized beam, and the blue light beam of the S-polarized light.

The combining optical device 6 is for combining the optical images respectively formed by the first optical system 4 and the second optical system 5, and has a substantially square planar shape obtained by bonding two triangular prisms with each other, and on the interfacial surface on which the prisms are bonded with each other, there is formed a dielectric multilayer film. Similar to the polarization splitting device 3 described above, the dielectric multilayer film is formed as a polarization splitting film for transmitting the P-polarized light while reflecting the S-polarized light.

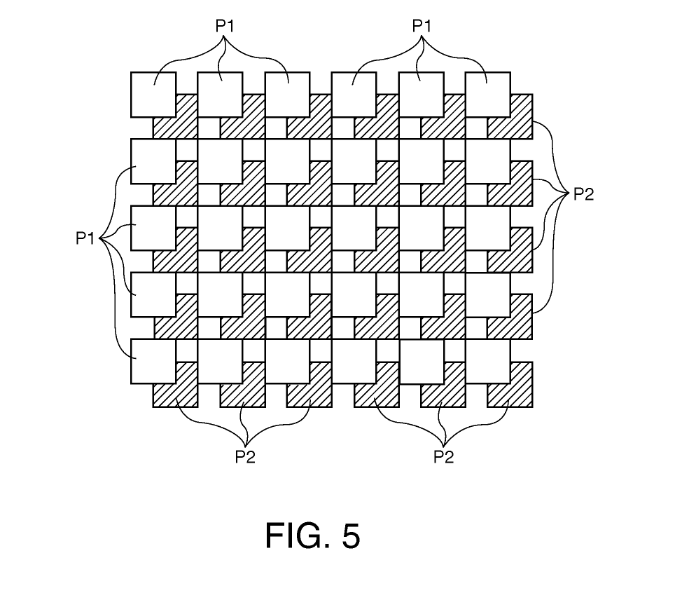

As shown in FIG. 5, the combining optical system 6 slides the pixels P2 of the second optical system 5 a half pixel in the lateral direction and a half pixel in the vertical direction with respect to the pixels P1 of the first optical system 4 to thereby combine the optical images of the respective optical systems 4, 5.

Although not shown in FIG. 1, the projection optical system 7 is formed of a combination lens composed of a plurality of lenses disposed in a lens tube with optical axes matched with each other, and for projecting the optical image combined into by the combining optical system 6 on a projection surface.

In such a projector 1 according to the present embodiment, the first optical system 4 is provided with the rotatable transparent parallel plate 45 disposed between the light modulation device 43 and the combining optical system 6, and rotates the transparent parallel plate 45 at a predetermined tilt angle (α) around the Y-axis perpendicular to the normal line A of the light emitted from the color polarizer 44 using the tilt angle adjustment mechanism 9.

Therefore, it becomes possible to slide the optical images a half pixel pitch from each other using a simple configuration of rotating the transparent parallel plate 45 in a specific direction using the tilt angle adjustment mechanism 9. Further, since the optical image slid a half pixel pitch therefrom and the optical image emitted from the second optical system 5 are combined in the combining optical system 6, and the optical image thus obtained by the combining operation is projected by the projection optical system 7, higher precision in the projection image can be realized.

Further, since the optical image is slid by rotating the transparent parallel plate 45, the configuration in which the position adjustment of the entire optical device is possible can be eliminated, and the downsizing, the weight saving, and the reduction in the cost, of the projector 1 can be achieved.

### Second Embodiment

A second embodiment of the invention will hereinafter be described. It should be noted that in the explanations described above, the parts having already been explained are denoted by the same reference numerals, and the explanations therefor will be omitted.

In the projector 1 according to the first embodiment described above, the polarization splitting device 3 is disposed posterior to the illumination optical device 2, and splits the light emitted from the illumination optical device 2 into the P-polarized light and the S-polarized light, the first optical system 4 forms the optical image based on the S-polarized light, and then slides the optical image, thus formed, a half pixel pitch, and the second optical system 5 forms the optical image based on the P-polarized light, and the combining optical system 6 combines the respective optical images with each other to thereby form the projection image.

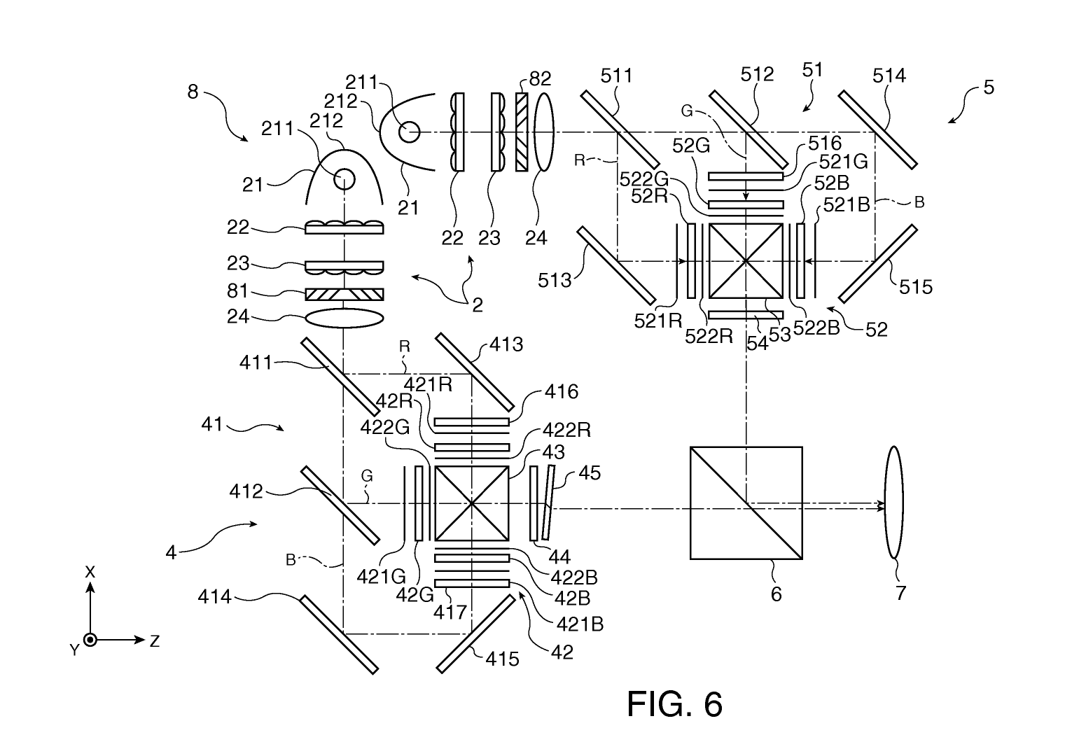

In contrast thereto, the projector 8 according to the second embodiment is different from the first embodiment in that, the illumination optical device 2 is provided to each of the first optical system 4 and the second optical system 5, the first optical system 4 and the second optical system 5 respectively form the optical images based on the light emitted respectively from the illumination optical devices 2, and the first optical system 4 slides the optical image, thus formed, a half pixel pitch, and the combining optical system 6 combines the respective optical images to thereby form the projection image, as shown in FIG. 6.

Further, in the projector 1 according to the first embodiment described above, the optical image formed by the first optical system 4 is slid a half pixel pitch using the tilt angle adjustment mechanism 9.

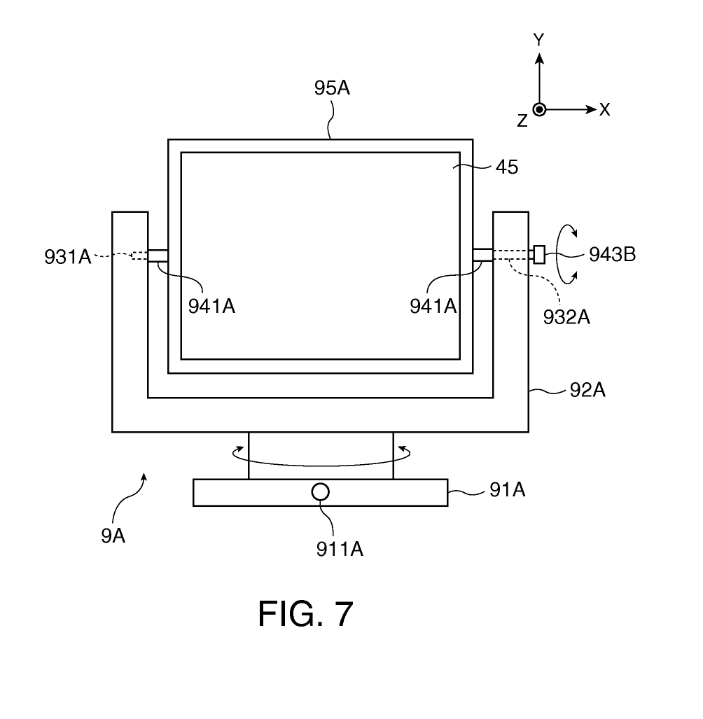

In contrast, the projector 8 according to the second embodiment is different therefrom in that the optical image is slid a half pixel pitch around the X-axis and the Y-axis using a tilt angle adjustment mechanism 9A as shown in FIG. 7.

In FIG. 7, the optical image emitted from the color polarizer 44 is transmitted through the transparent parallel plate 45 from the back of the sheet toward the front thereof.

Between the second lens array 23 and the overlapping lens 24 of each of the illumination optical devices 2, there is disposed a polarization conversion element 81 (82). The polarization conversion elements 81, 82 are each provided for converting the light emitted from the illumination optical device 2 into substantially the same type of linearly polarized light, and the polarization conversion element 81 for the first optical system 4 converts the light emitted from the illumination optical device 2 into the S-polarized light. On the other hand, the polarization conversion element 82 for the second optical system 5 converts the light emitted from the illumination optical device 2 into the P-polarized light.

The polarization conversion elements 81, 82 are each a plate like member formed by bonding a plurality of prisms with each other on the oblique planes thereof, each of the prisms having a parallelogram shape with one diagonal angles of 45 degrees and the other diagonal angles of 135 degrees, and a polarization splitting film and a total reflection film are deposited alternately on the interfaces on which the prisms are bonded.

Further, on the light exit surface of each of the polarization conversion elements 81, 82, there is disposed a plurality of half wave retardation plates at a predetermined pitch.

In such polarization conversion elements 81, 82, when the light is input to the surface provided with the polarization splitting film, the P-polarized light is directly transmitted therethrough and then emitted therefrom, while the S-polarized light is folded substantially orthogonally by the polarization splitting film, and then emitted therefrom after being folded orthogonally again by the total reflection mirror.

Either one of the P-polarized light and the S-polarized light thus emitted is converted 90 degrees in the polarization direction by the half wave retardation plate disposed in the posterior stage, and thus, it becomes possible to convert the light input thereto into the same type of the linearly polarized light. It should be noted that the polarization conversion element 81 has the half wave retardation plate disposed at the position corresponding to the polarization splitting film, and the polarization conversion element 82 has the half wave retardation plate disposed at the position corresponding to the total reflection mirror.

As shown in FIG. 7, the tilt angle adjustment mechanism 9A has a configuration of rotatably supporting a frame member 92A on a support stage 91A, and further rotatably supporting a holding frame 95A with respect to the frame member 92A.

The frame member 92A supported on the support stage 91A is arranged to be rotatable around the Y-axis, and by rotating the frame member 92A, it becomes possible to rotate the transparent parallel plate 45 around the Y-axis. It should be noted that similarly to the first embodiment, the frame member 92A is rotated using a Y-axis rotation adjustment knob 911A disposed on the support stage 91A.

The frame member 92A is formed of a metal member having a substantially U-shaped front view, and one end of the upper portions of the U-shape is provided with a hole 931A formed on a side surface facing the other of the upper portions of the U-shape, and the other end of the upper portions is provided with a through hole 932A.

The holding frame 95A houses the transparent parallel plate 45 inside the rectangular frame to thereby hold the transparent parallel plate 45, and at the same time, both ends of roughly the center of the end portions opposed to each other in the horizontal direction of the rectangular shape are respectively provided with rotatable coupling members 941A.

One of the rotatable coupling members 941A is inserted into the hole 931A, the other of the rotatable coupling members 941A is inserted into the through hole 932A, and it is arranged that the rotational adjustment of the transparent parallel plate 45 around the X-axis can be performed using an X-axis rotation adjustment knob 943B attached to the through hole 932A from the outside of the frame member 92A.

In such a projector 8 according to the second embodiment, since the illumination optical devices 2 for respectively supplying the optical systems 4, 5 with light are provided thereto independently from each other, strong light intensity can be ensured in the optical images formed in the respective optical systems 4, 5, and thus the higher intensity of the projection image can be achieved in addition to the advantages of the projector 1 according to the first embodiment described above.

Further, since the light intensity of the light emitted from each of the illumination optical devices 2 can be adjusted by independently controlling driving of the respective illumination optical devices 2, the luminance variation, the color variation, and so on in the projection image obtained by the combining operation of the combining optical system 6 can further be reduced.

Further, since the projector 8 is of a gimbal type, the rotational center in the X-axis direction and the center of the transparent parallel plate 45 always match with each other. Therefore, since the transparent parallel plate 45 can be rotated in accordance with the rotational angle of the rotatable coupling members 941A, the tilt angle adjustment mechanism 9A can easily rotate the transparent parallel plate 45 with relatively small amount of rotation of the Z-X rotatable coupling members 941A compared to the tilt angle adjustment mechanism 9 provided with a so-called gonio-stage.

### Third Embodiment

A third embodiment of the invention will hereinafter be explained. It should be noted that in the explanations described above, the parts having already been explained are denoted by the same reference numerals, and the explanations therefor will be omitted.

The projector 1 according to the first embodiment described above is provided with the tilt angle adjustment mechanism 9 for rotating the transparent parallel plate 45.

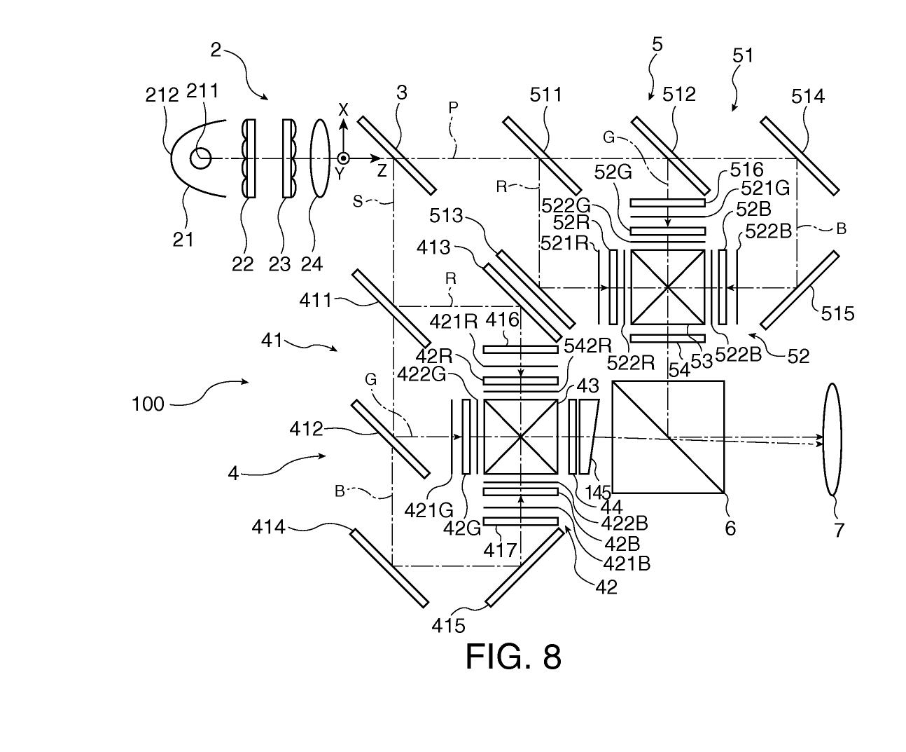

In contrast thereto, as shown in FIG. 8, the projector 100 according to the third embodiment is different therefrom in that it is provided with a variable angle prism 145.

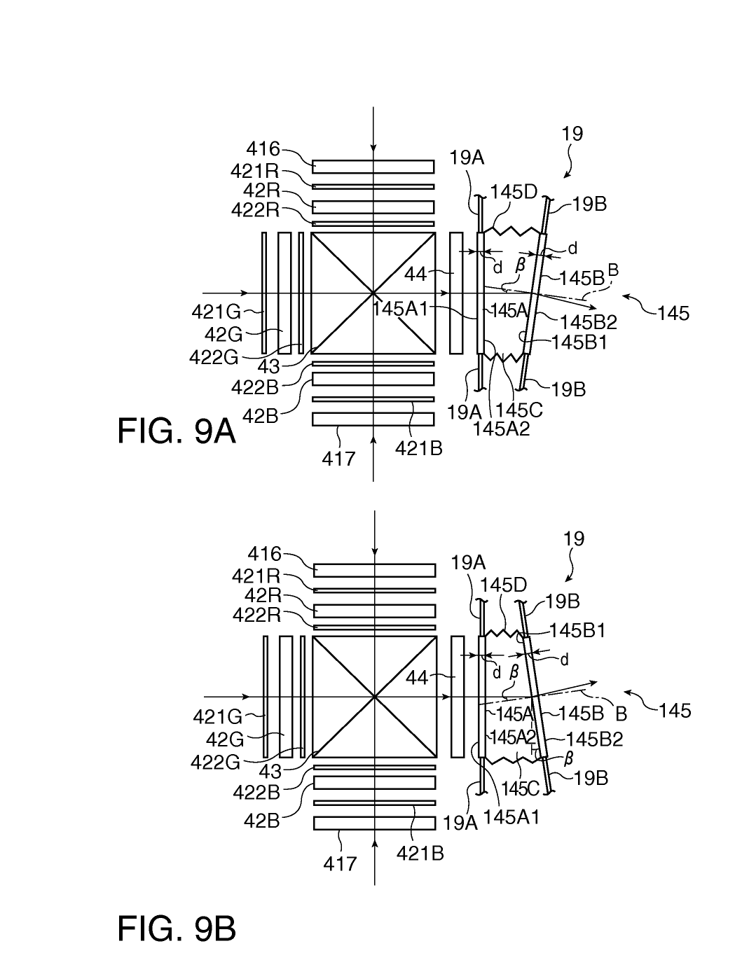

FIG. 8 shows a projector 100 according to an embodiment of the invention, and the projector 100 is provided with an illumination optical device 2, a polarization splitting device 3, a first optical system 4, a second optical system 5, a combining optical system 6, and a projection optical system 7. The first optical system 4 is provided with the variable angle prism 145. The variable angle prism 145 is disposed posterior to the color polarizer. Further, as shown in FIGS. 9A and 9B, the projector 100 is provided with a variable angle prism adjustment mechanism 19 for adjusting the tilt angle of the variable angle prism 145.

As shown in FIG. 9A, the variable angle prism 145 is an optical element provided with a pair of entrance side transparent substrate 145A and exit side transparent substrate 145B each having a rectangular shape disposed so as to face each other with a gap therebetween, and tilting at least either one (145A, 145B) of the pair of substrates 145A, 145B with respect to the axis of the principal ray of the light emitted from the light source device 21 by controlling the distance between the pair of substrates 145A, 145B. The axis of the principal ray of the light emitted from the light source device 21 is coincident with the normal line of the image forming area of the light modulation device 42.

In the peripheral end of each of the pair of substrates 145A, 145B, there is provided an accordion seal member 145C, and inside the seal member 145C, there is airtightly encapsulated a transparent liquid 145D.

In such a variable angle prism 145 as described above, when the force for making the entrance side transparent substrate 145A and the exit side transparent substrate 145B come closer to each other is applied to either one of the end portions thereof, the transparent liquid 145D encapsulated therein flows to a part other than the part to which the force has been applied, and the distance between the entrance side transparent substrate 145A and the exit side transparent substrate 145B in the part to which the force is applied decreases, and thus, the exit side transparent substrate 145B is disposed so as to be tilted with respect to the axis of the principal ray of the light from the light source device 21.

The variable angle prism adjustment mechanism 19 is a mechanism for applying the force for making the pair of substrates 145A, 145B of the variable angle prism 145 come closer to each other to thereby adjust the tilt angle of the exit side transparent substrate 145B with respect to the axis of the principal ray, and is provided with entrance side chucks 19A disposed at the four corners of the entrance side transparent substrate 145A and the exit side transparent substrate 145B each having a rectangular shape, and for clamping the entrance side transparent substrate 145A, exit side chucks 19B for clamping the exit side transparent substrate 145B, and an actuator for applying the drive force to these chucks 19A, 19B.

The variable angle prism adjustment mechanism 19 fixes the entrance side transparent substrate 145A by the entrance side chucks 19A, and makes the end portion on the exit side polarization plate 422B side of the exit side transparent substrate 145B is made to come closer to the entrance side transparent substrate 145A side using the exit side chucks 19B.

The entrance side transparent substrate 145A has the entrance side end surface 145A1 perpendicular to the axis of the principal ray, and transmits the light input thereto. The exit side transparent substrate 145B is tilted so that the normal line B of the exit side end surface 145B1 is at a predetermined tilt angle (β degree) with the axis of the principal ray.

The tilt angle (β degree) preferably satisfies 0<β≦10, and further preferably satisfies 0≦β≦5. If the tilt angle (β degree) exceeds 10 degrees, the astigmatism might increase to make the imaging performance unworkable.

Further, the total thickness (d) of the entrance side transparent substrate 145A, the exit side transparent substrate 145B, and the transparent liquid 145D is preferably no smaller than 1 mm and no larger than 30 mm, is further preferably no smaller than 5 mm and no larger than 10 mm. In the case in which the thickness is smaller than 1 mm, the strength of the entrance side transparent substrate 145A and the exit side transparent substrate 145B becomes insufficient, which might cause it to be prone to be damaged, or might cause the amount of sliding of the optical image to become insufficient. On the other hand, in the case in which the thickness thereof exceeds 30 mm, since the amount of sliding of the optical image corresponding to only a slight variation in the tilt angle of the entrance side transparent substrate 145A and the exit side transparent substrate 145B becomes large, it might become difficult to perform a fine adjustment by the variable angle prism adjustment mechanism 19.

It should be noted that the exit side chucks 19B can change the direction of tilt of the exit side transparent substrate 145B as shown in FIG. 9B. For example, an actuator makes the end portion on the entrance side polarization plate 422R side of the entrance side transparent substrate 145A and the end portion on the entrance side polarization plate 422R side of the exit side transparent substrate 145B come closer to each other using the exit side chucks 19B. Thus, the end portion on the entrance side polarization plate 422B side of the entrance side transparent substrate 145A and the end portion on the entrance side polarization plate 422B side of the exit side transparent substrate 145B are made to be distant from each other. Therefore, the light path is shifted to the entrance side polarization plate 422R side.

Further, although not shown in the drawings, in the case in which the exit side end surface 145B1 is perpendicular to (β=0) the axis of the principal beam, the light path is not shifted. Further, although the optical image is slid around the X-axis as shown in FIGS. 9A and 9B by the actuator adjusting the tilt angle (β) of the exit side transparent substrate 145B using the exit side chucks 19B, it is also possible to tilt the exit side transparent substrate 145B by the exit side chucks 19B so that the light path is slid around the Z-axis. Further, although there is adopted the configuration of tilting the entrance side transparent substrate 145A and the exit side transparent substrate 145B by the entrance side chucks 19A and the exit side chucks 19B, respectively, it is also possible to couple a shaft to each of the entrance side transparent substrate 145A and the exit side transparent substrate 145B, and then rotate the shaft itself to thereby tilt the entrance side transparent substrate 145A and the exit side transparent substrate 145B.

The entrance side transparent substrate 145A and the exit side transparent substrate 145B are preferably made of a glass material. As the glass material, BK7, quartz glass, crystallized glass, and so on can be adopted. Further, the glass material preferably has characteristics of nd=1.51680, and rd=64.2.

In such a projector 100 according to the present embodiment, in the first optical system 4, there is disposed between the color combining optical device 43 and the combining optical system 6 the variable angle prism 145 having the exit side transparent substrate 145B disposed so as to be tilted with respect to the axis of the principal ray coincident with the normal line of the image forming area of the light modulation device 42, and the exit side transparent substrate 145B is tilted by the variable angle prism adjustment mechanism 19 to thereby adjust the tilt angle (β).

Therefore, it becomes possible to slide the optical images a half pixel pitch from each other using a simple configuration of tilting the exit side transparent substrate 145B in a specific direction by the variable angle prism adjustment mechanism 19. Further, since the optical image slid a half pixel pitch therefrom and the optical image emitted from the second optical system 5 are combined in the combining optical system 6, and the optical image thus obtained by the combining operation is projected by the projection optical system 7, higher precision in the projection image can be realized.

Further, since the optical image is slid by tilting the exit side transparent substrate 145, the configuration in which the position adjustment of the entire optical device is possible can be eliminated, and the downsizing, the weight saving, and the reduction in the cost, of the projector 1 can be achieved.

### Fourth Embodiment

A fourth embodiment of the invention will hereinafter be explained. It should be noted that in the explanations described above, the parts having already been explained are denoted by the same reference numerals, and the explanations therefor will be omitted.

In the projector 100 according to the third embodiment described above, the polarization splitting device 3 is disposed posterior to the illumination optical device 2, and splits the light emitted from the illumination optical device 2 into the P-polarized light and the S-polarized light, the first optical system 4 forms the optical image based on the S-polarized light, and then slides the optical image, thus formed, a half pixel pitch, and the second optical system 5 forms the optical image based on the P-polarized light, and the combining optical system 6 combines the respective optical images with each other to thereby form the projection image.

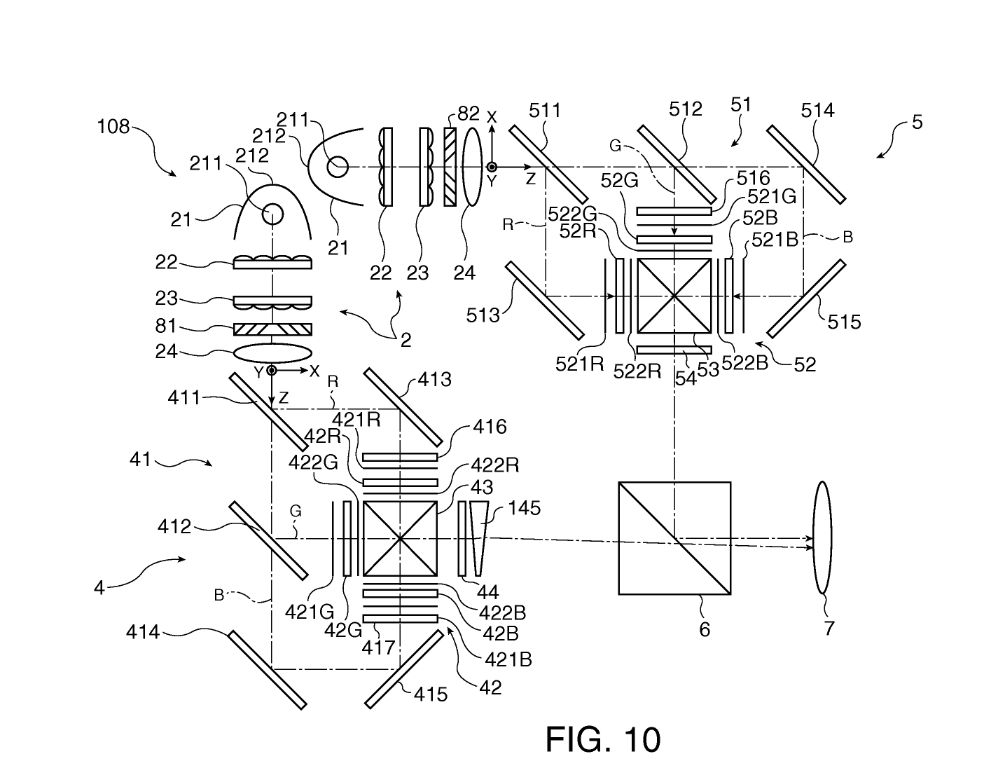

In contrast thereto, the projector 108 according to the fourth embodiment is different therefrom in that, the illumination optical device 2 is provided to each of the first optical system 4 and the second optical system 5, the first optical system 4 and the second optical system 5 respectively form the optical images based on the light emitted respectively from the illumination optical devices 2, and the first optical system 4 slides the optical image, thus formed, a half pixel pitch, and the combining optical system 6 combines the respective optical images to thereby form the projection image as shown in FIG. 10.

Further, in the projector 100 according to the third embodiment described above, the entrance side transparent substrate 145A is fixed by the entrance side chucks 19A, and the exit side transparent substrate 145B is tilted with the tilt angle (β) by the exit side chuck 19B.

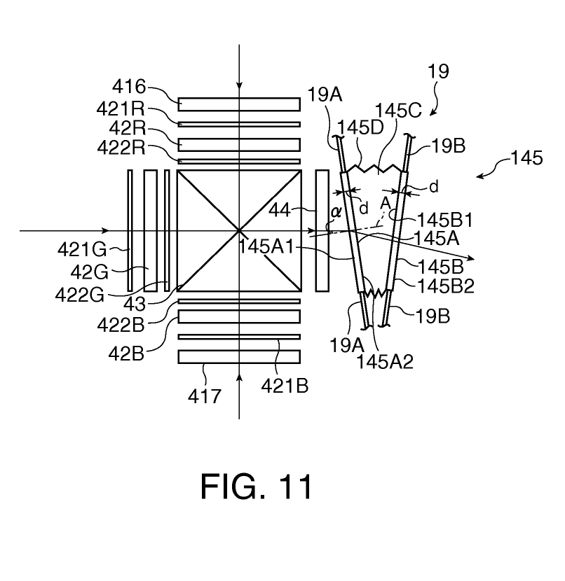

In contrast thereto, the projector 108 according to the fourth embodiment is different therefrom in that the optical image is slid a half pixel pitch by an actuator tilting the entrance side transparent substrate 145A using the entrance side chucks 19A as shown in FIG. 11.

Between the second lens array 23 and the overlapping lens 24 of each of the illumination optical devices 2, there is disposed a polarization conversion element 81 (82). The polarization conversion elements 81, 82 are each provided for converting the light emitted from the illumination optical device 2 into substantially the same type of linearly polarized light, and the polarization conversion element 81 for the first optical system 4 converts the light emitted from the illumination optical device 2 into the S-polarized light. On the other hand, the polarization conversion element 82 for the second optical system 5 converts the light emitted from the illumination optical device 2 into the P-polarized light.

The polarization conversion elements 81, 82 are each a plate like member formed by bonding a plurality of prisms with each other on the oblique planes thereof, each of the prisms having a parallelogram shape with one diagonal angles of 45 degrees and the other diagonal angles of 135 degrees, and a polarization splitting film and a total reflection film are deposited alternately on the interfaces on which the prisms are bonded.

Further, on the light exit surface of each of the polarization conversion elements 81, 82, there is disposed a plurality of half wave retardation plates at a predetermined pitch.

In such polarization conversion elements 81, 82, when the light is input to the surface provided with the polarization splitting film, the P-polarized light is directly transmitted therethrough and then emitted therefrom, while the S-polarized light is folded substantially orthogonally by the polarization splitting film, and then emitted therefrom after being folded orthogonally again by the total reflection mirror.

Either one of the P-polarized light and the S-polarized light thus emitted is converted 90 degrees in the polarization direction by the half wave retardation plate disposed in the posterior stage, and thus, it becomes possible to convert the light input thereto into the same type of the linearly polarized light. It should be noted that the polarization conversion element 81 has the half wave retardation plate disposed at the position corresponding to the polarization splitting film, and the polarization conversion element 82 has the half wave retardation plate disposed at the position corresponding to the total reflection mirror.

The actuator makes the end portion on the exit side polarization plate 422R side of the entrance side transparent substrate 145A come closer to the end portion on the exit side polarization plate 422R side of the exit side transparent substrate 145B using the entrance side chucks 19A.

Further, the actuator tilts the entrance side transparent substrate 145A so that the normal line A of the entrance side end surface 145A1 has a predetermined tilt angle (α) with respect to the axis of the principal ray. Thus, the optical image is slid from the entrance side end surface 145A1 around the Y-axis.

Similarly to the tilt angle (β degree) described above, the tilt angle (α degree) preferably satisfies 0<α≦10, and further preferably satisfies 0α≦5. In the case in which the tilt angle (α degree) exceeds 10 degrees, preferable correction of the position of the optical image might be unsuccessful.

In such a projector 108 according to the fourth embodiment, since the illumination optical devices 2 for respectively supplying the optical systems 4, 5 with light are provided thereto independently from each other, strong light intensity can be ensured in the optical images formed in the respective optical systems 4, 5, and thus the higher intensity of the projection image can be achieved in addition to the advantages of the projector 100 according to the third embodiment described above.

Further, since the light intensity of the light emitted from each of the illumination optical devices 2 can be adjusted by independently controlling driving of the respective illumination optical devices 2, the luminance variation, the color variation, and so on in the projection image obtained by the combining operation of the combining optical system 6 can further be reduced.

Further, the actuator tilts the entrance side transparent substrate 145A so that the normal line A of the entrance side end surface 145A1 has a tilt angle (α) with respect to the axis of the principal ray. Therefore, since the optical image is slid from the entrance side end surface 145A1 around the Y-axis, it is possible to increase the amount of sliding of the optical image compared to the case in which the optical image is slid from the exit side transparent substrate 145B. Therefore, it is possible to easily slide the optical image a half pixel pitch.

### Fifth Embodiment

A fifth embodiment of the invention will hereinafter be explained. It should be noted that in the explanations described above, the parts having already been explained are denoted by the same reference numerals, and the explanations therefor will be omitted.

In the projector 100 according to the third embodiment described above, the variable angle prism 145 is disposed between the color polarizer 44 and the combining optical system 6.

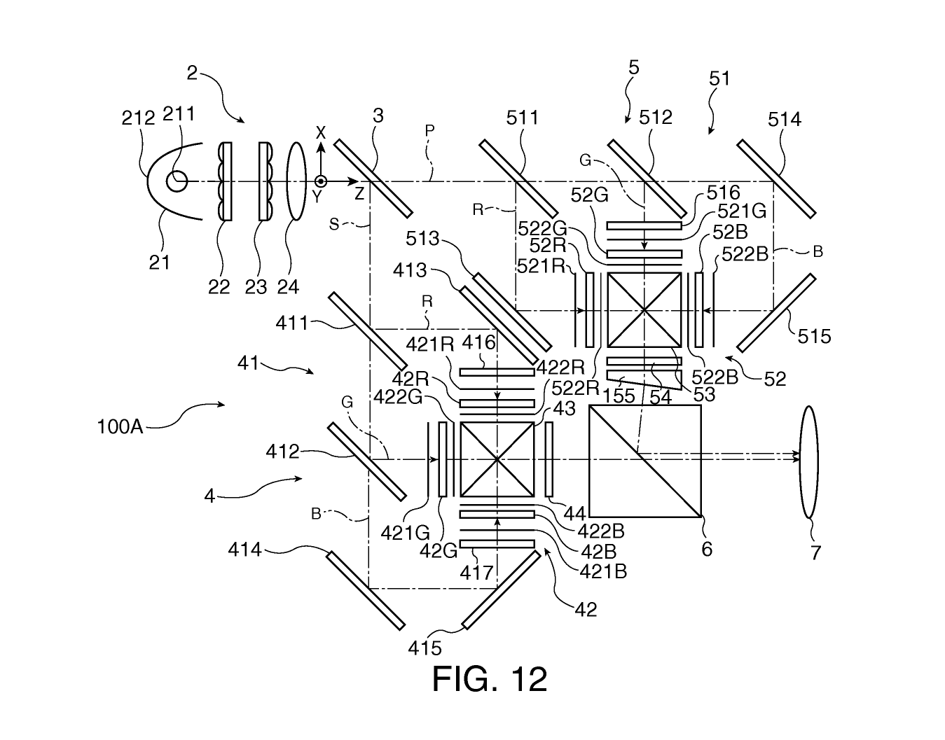

In contrast thereto, the projector 100A according to the fifth embodiment is different therefrom in that a variable angle prism 155 is disposed between the color polarizer 54 and the combining optical system 6 as shown in FIG. 12.

The variable angle prism 155 supplies the combining optical system 6 with the S-polarized light emitted from the color polarizer 54. The combining optical system 6 refracts the S-polarized light supplied from the variable angle prism 155, and then reflects it toward the projection optical system 7.

In such a projector 100A according to the fifth embodiment, the following advantage is obtained in addition to the advantages of the projector 100 according to the third embodiment described above.

The combining optical system 6 reflects the S-polarized light, which is supplied from the variable angle prism 155, toward the projection optical system 7.

Therefore, since the S-polarized light has low incident angle dependency, even if the tilt angle (α) of the exit side end surface 145B1 varies, the S-polarized light is reflected by the combining optical system 6 in accordance with the variation. Therefore, the pixel matching can be performed with better accuracy.

### Modifications of Embodiments

It should be noted that the invention is not limited to the embodiments described above, but includes the modifications described below.

Although in the embodiments described above the transmissive liquid crystal panels 42R, 42G, 42B, 52R, 52G, 52B are adopted as the light modulation device, the invention is not limited thereto, but it is also possible to configure the two optical systems with the devices using reflective liquid crystal panels or micromirror devices, and to adopt the invention to the projector for combining them to project the projection image.

Besides the above, specific structures and shapes to be adopted when putting the invention into practice can be replaced with other structures and so on within the range in which the advantage of the invention can be achieved.

The invention can be applied to a projector provided with a plurality of color combining optical systems, such as a so-called 6-LCD projector.

The entire disclosure of Japanese Patent Application NOs. 2009-025656, filed Feb. 6, 2009 and 2009-038945, filed Feb. 23, 2009 are expressly incorporated by reference herein.

What is claimed is:

1. A projector comprising:
a first optical system and a second optical system each having a light modulation device adapted to modulate light, which is emitted from a light source device, in accordance with image information input, and to form an optical image;
a combining optical system adapted to combine the optical images respectively formed by the first optical system and the second optical system; and
a projection optical system adapted to project the combined optical image combined into by the combining optical system,
wherein either one of the first optical system and the second optical system includes
a transparent parallel plate disposed between the light modulation device and the combining optical system in a rotatable manner, and
a tilt angle adjustment mechanism adapted to rotate the transparent parallel plate with respect to a first axis perpendicular to a normal line of an entrance surface of the light modulation device and a second axis perpendicular to the normal line and the first axis to adjust a tilt angle of the transparent parallel plate with respect to the normal line.

2. The projector according to claim 1, wherein
the light source device includes
a light source, and
a polarization splitting device adapted to split the light emitted from the light source into P-polarized light parallel to an entrance surface and S-polarized light perpendicular to the entrance surface,
the first optical system forms the optical image based on the P-polarized light split into by the polarization splitting device, and
the second optical system forms the optical image based on the S-polarized light split into by the polarization splitting device.

3. The projector according to claim 1, wherein
each of the first optical system and the second optical system includes
a color separation device adapted to separate incident light sequentially one of from longer wavelength band to shorter wavelength band and from shorter wavelength band to longer wavelength band into a red light beam, a green light beam, and a blue light beam,
three light modulation sections corresponding to the light modulation device, and adapted to modulate the respective colored light beams, which are separated into by the color separation device, in accordance with the input image information to thereby form the optical images,
a color combining optical device adapted to combine the optical images of the respective colored light beams formed by the respective light modulation sections, and
a color polarizer disposed between the color combining optical device and the combining optical system, and adapted to change a polarization direction of the green light beam, and
the transparent parallel plate is provided to the color polarizer.

4. The projector according to claim 1, wherein
the transparent parallel plate has a thickness equal to or larger than 0.5 mm and equal to or smaller than 30 mm.

5. The projector according to claim 1, wherein
the tilt angle adjustment mechanism sets the tilt angle of the transparent parallel plate with respect to the normal line within a range larger than 0 and equal to or smaller than 5 degrees.

6. The projector according to claim 1, wherein
the transparent parallel plate is made of a glass material.

7. A projector comprising:
a first optical system and a second optical system each having a light modulation device adapted to modulate light, which is emitted from a light source device, in accordance with image information input, and to form an optical image;
a combining optical system adapted to combine the optical images respectively formed by the first optical system and the second optical system;
a projection optical system adapted to project the combined optical image combined into by the combining optical system;
a variable angle prism having a pair of transparent substrates disposed between the light modulation device and the combining optical system so as to face each other with a gap, and adapted to control a distance between the pair of transparent substrates to thereby tilt at least either of the pair of transparent substrate with respect to a normal line of an image forming area of the light modulation device; and
a variable angle prism adjustment mechanism adapted to adjust the tilt angle of at least either one of the pair of transparent substrates in the variable angle prism with respect to the normal line.

8. The projector according to claim 7, wherein
the light source device includes
a light source, and
a polarization splitting device adapted to split the light emitted from the light source into P-polarized light parallel to an entrance surface and S-polarized light perpendicular to the entrance surface,
the first optical system forms the optical image based on the P-polarized light split into by the polarization splitting device, and
the second optical system forms the optical image based on the S-polarized light split into by the polarization splitting device.

9. The projector according to claim 7, wherein
each of the first optical system and the second optical system includes
a color separation device adapted to separate incident light sequentially one of from longer wavelength band to shorter wavelength band and from shorter wavelength band to longer wavelength band into a red light beam, a green light beam, and a blue light beam,
three light modulation sections corresponding to the light modulation device, and adapted to modulate the respective colored light beams, which are separated into by the color separation device, in accordance with the input image information to thereby form the optical images,
a color combining optical device adapted to combine the optical images of the respective colored light beams formed by the respective light modulation sections, and
a color polarizer disposed between the color combining optical device and the combining optical system, and adapted to change a polarization direction of the green light beam, and
the variable angle prism is provided to the color polarizer.

10. The projector according to claim 7, wherein
the variable angle prism is disposed so as to be able to transmit the optical image of the S-polarized light emitted from one of the first optical system and the second optical system, and
the combining optical system includes a reflective polarizer disposed between the variable angle prism and the projection optical system, and adapted to reflect the optical image of the S-polarized light emitted from the variable angle prism and then supply the projection optical system with the optical image.
